(19) United States
(12) Patent Application Publication
(10) Pub. No.: US 2019/0078713 A1
(43) Pub. Date: Mar. 14, 2019

(54) HOSE CONNECTION WITH AN ELASTOMER HOSE

(71) Applicant: Mahle International GmbH, Stuttgart (DE)

(72) Inventors: Samuel Kohler, Weil im Schoenbuch (DE); Jan Schuessler, Koenigsbach-Stein (DE)

(21) Appl. No.: 16/125,605

(22) Filed: Sep. 7, 2018

(30) Foreign Application Priority Data
Sep. 8, 2017 (DE) 102017215896.4

(51) Int. Cl. F16L 33/22

(52) U.S. Cl. CPC F16L 33/223

(57) ABSTRACT

The invention concerns an elastomer hose to connect to a nozzle, wherein the elastomer hose comprises a circumferential edge at least at a longitudinal end. In one exemplary approach a support structure protrudes from a first circumferential section of the circumferential edge and by which the longitudinal end of the elastomer hose is connectable in a positively form-locking manner to a complementary counter-support structure on the nozzle. Additionally, a grip structure protruding from the circumferential edge in a second circumferential section, which is offset from the first circumferential section in a circumferential direction, at which the longitudinal end, is manually grippable when connecting the elastomer hose to the nozzle axially pullable up on to the nozzle.

### CROSS-REFERENCE TO RELATED APPLICATIONS

This application claims priority to German Patent Application No. DE 10 2017 215 896.4, filed on Sep. 8, 2017, the contents of which are hereby incorporated by reference in its entirety.

### TECHNICAL FIELD

The present invention relates to an elastomer hose. The invention furthermore relates to a hose connection equipped with such an elastomer hose, in particular, in a fresh-air system of an internal combustion engine. The present invention further relates to another method to manufacture such a hose connection.

### BACKGROUND

An elastomer hose according to this class is, for example, known from DE 10 2004 063 459 A1. The elastomer hose serves to connect to a nozzle. Thereby, the known elastomer hose is used to connect a venting device of an internal combustion engine to a fresh-air system of the internal combustion engine in order to return blow-by gas from the crankcase of the internal combustion engine to the fresh-air system. The elastomer hose comprises a circumferential edge on a longitudinal end. In the case of the known elastomer hose, a plurality of breakthroughs distributed in the circumferential direction are formed on the longitudinal end, being axially distanced from the circumferential edge. Complementary to the breakthroughs barbs on formed on the related nozzle, which radially engage through breakthroughs onto the nozzle from the inside during insertion of the elastomer hose in order to fix the elastomer hose onto the nozzle in an axial manner.

When installing such an elastomer hose, the longitudinal end is manually inserted onto the nozzle, thereby being pressurized. Thereby, the edge can collide with a face side of the nozzle. The elasticity allows for the longitudinal end to slightly deform, whereby, in the case of such a collision and the pressure forces, it can deform and fold in. This fold-in on the longitudinal end inserted onto the nozzle may remain unnoticed by the respective installer, whereby the hose connection is not sufficiently tight.

### SUMMARY

The present invention deals with the problem of indicating an improved or at least another embodiment for such an elastomer hose or for a hose connection equipped with it, which is particularly characterized in that a fault-free installation is simplified.

According to the invention, this problem is solved by means of the object of the independent claims. Favourable embodiments are the object of the dependent claims.

The invention is based on the general idea, on the one hand, to form a support structure on the edge of the longitudinal end to be inserted onto the nozzle and, on the other, a grip structure. Thereby, the support structure is conceived in such a way that the longitudinal end can be axially attached in a positively form-locking manner to the counter-support structure that is complementary to it formed on the nozzle when connecting the elastomer hose to the nozzle. In contrast, the grip structure is designed in such a way that an installer can manually grip the longitudinal end on this grip structure in order to be able to pull up the longitudinal end when axially connecting the elastomer hose to the nozzle. By means of this, the elasticity of the elastomer hose is taken advantage of during installation. In order to attach the longitudinal end to the nozzle with the help of the support structure, the longitudinal end must be applied at an angle, meaning inclined toward an axial orientation to the nozzle. In order to fully be able to insert the longitudinal end onto the nozzle, the longitudinal end of the elastomer hose must be elastically deformed. This takes place when pulling on the grip structure. Thereby, the hose end is completely pulled over the nozzle At the same time, a coaxial orientation between the longitudinal end of the elastomer hose and the nozzle is achieved. While, in the case of the presently described most recent prior art, the longitudinal end of the elastomer hose is pressed onto the nozzle under pressure, in the case of the elastomer hose according to the invention, a pulling up of the longitudinal end onto the nozzle subject to an axial tensile load takes place. By means of this, such fold-ins on the edge can be avoided. Due to avoiding fold-ins, the desired tightness is ensured.

In the case of the elastomer hose according to the invention, the support structure protrudes from the of the longitudinal end of the elastomer hose in a first circumferential section while the grip structure protrudes from the edge of the longitudinal end of the elastomer hose in a second circumferential section. Thereby, the second circumferential section is offset to the first circumferential section in the circumferential direction.

In accordance with a favourable embodiment, it can be provided that the support structure extends in the circumferential direction of the edge across a maximum of 90°. In addition or as an alternative, it can be provided that the grip structure extends in the circumferential direction of the edge across a maximum of 90°. In this way, it is clear that the edge can elastically deform in the circumferential direction between the support structure and the grip structure when pulling up onto the nozzle

An embodiment is expedient where the grip structure is arranged on the edge offset to the support structure by at least 90° and a maximum of 180° in the circumferential direction of the edge. Thereby, an embodiment is preferred where the support structure and the grip structure on the edge primarily lie diametrically opposite to one another. By means of this, the pulling up of the elastomer hose onto the nozzle is simplified.

An embodiment is particularly favourable where the grip structure and the support structure are designed and arranged in such a way that a two-phase installation can be implemented to connect the elastomer hose to the nozzle, wherein, during a first installation phase, the support structure of the elastomer hose is attached to the counter-support structure of the nozzle in such a way that the grip structure is axially distanced away from the nozzle at the end of the first installation phase and wherein the longitudinal end of the elastomer hose is pulled up onto the nozzle during a subsequent second installation phase in such a way that the distance between the grip structure and the nozzle declines.

In addition or as an alternative, it can be provided that the support structure or the counter-support structure are designed and/or match each other in such a way that the support structure attached to the counter-support structure defines a swivel axis, around which the longitudinal end of the elastomer hose can be swivelled when pulling up over the nozzle.

In addition or as an alternative, it can be provided that the longitudinal end of the elastomer hose defines a hose-longitudinal centre axis while the nozzle defines a nozzle-longitudinal centre axis, wherein the hose-longitudinal centre axis runs inclined toward the nozzle-longitudinal centre axis after attaching the support structure of the elastomer hose to the counter-support structure of the nozzle and before pulling up the longitudinal end onto the nozzle, while the hose-longitudinal centre axis runs parallel to the nozzle-longitudinal centre axis after attaching the support structure of the elastomer hose to the counter-support structure of the nozzle and after pulling up the longitudinal end onto the nozzle.

As described further above, the above-mentioned measures lead to the elastomer hose being subjected to tensile strain and not pressure strain, which would reduce the formation of kinks.

In accordance with a favourable embodiment, the elastomer hose can comprise an oval cross-section at least in the area of the longitudinal end so that the edge comprises two diametrically opposite short circumferential sections with smaller curvature radii in addition to two diametrically opposite long circumferential sections with larger curvature radii offset by 90°. Such oval, in particular, elliptical cross sections can be favourable in the case of certain installation-space situations. In accordance with a preferred further embodiment, it can be provided that the support structure is arranged in the one short circumferential section while the grip structure is arranged in the other short circumferential section. By means of this, it is ensured that, during installation, the elastic deformation of the longitudinal end primarily occurs in the long circumferential sections, which have a greater amount of elasticity than the short circumferential sections. By means of this, insulation a simplified.

In accordance with another embodiment, the grip structure can comprise a grip section that radially protrudes from the edge and a second grip section that axially protrudes from the first grip section. By means of this, the grip structure can, in particular, possess an L-shaped profile, which facilitates the manual gripping of the grip structure.

Another embodiment provides that the support structure comprises a bracket that axially protrudes from the edge and extends into the circumferential direction of the edge, which comprises a holding contour inside in the radial direction, on which the counter-support structure of the nozzle can engage in positively form-locking manner to attach the longitudinal end. By means of this, a particularly efficient axial fixation is implemented between the support structure and counter-support structure when mounting elastomer hose.

In accordance with a further embodiment, the bracket can hook into a bracket opening, which enters into the bracket in radial direction or enters into the bracket in the real direction without penetrating this. By means of this, a positively form-locking engagement between the support structure and the counter-support structure is facilitated. The support contour can expediently limit bracket opening an axial direction at a side that is remote from the edge. Thereby, the support contour encompasses the bracket opening and protrudes from the edge in the axial direction which is ultimately favourable for fixing the hose onto the nozzle.

In accordance with another embodiment, the longitudinal end of the elastomer hose can comprise a circumferential fitting groove radially on the outside, that is preferably closed, in which a clamp to attach the longitudinal add to the nozzle can be inserted. The longitudinal end of the elastomer hose that is attached to the nozzle is braced in the radial direction with the nozzle, whereby, on the one hand, a sufficient excellent fixation between the elastomer hose and the nozzle is implemented while, at the same time, sufficient tightness between the elastomer hose and the nozzle is ensured on the other.

For example, the elastomer hose can be designed as a bellow or at least comprise one longitudinal section designed as a bellow. Such a bellows allows for tolerance compensation to take place in a simple manner. At the same time, it allows for relative movements between the longitudinal end of the elastomer hose, which may occur during use of the elastomer hose within a motor vehicle.

A hose connection according to the invention, which, in particular, can be used within a fresh-air system of an internal combustion engine, is equipped with an elastomer hose of the previously described kind. Furthermore, this hose connection is equipped with a nozzle, which comprises a counter-support structure on the outside, which is engaged with the support structure of the elastomer hose in a positively form-locking manner.

In accordance with a favourable embodiment, the nozzle can comprise at least one axial end-stop on the outside, which interacts with an axial face side of the edge when connecting the elastomer hose. The axle and stop makes it easier to find a predetermined axial relative position between the elastomer hose and the nozzle.

A favourable further embodiment recommends that the axial end-stop abuts the face side of the edge in the circumferential direction between the support structure and the grip structure. To axial and stops can be expediently provided that are also diametrically opposite to each other.

Being fitting for the respective axial and stop, on its axial face side, the edge can comprise a depression formed to be complementary to the axial end-stop, which improves the positioning between the elastomer hose and the nozzle.

Within an internal combustion engine, the elastomer hose can be expediently used to connect a crankcase venting device on the output side to the fresh-air system in order to supply blow-by gases discharged from the crankcase to the fresh-air system. Usually, such a venting device contains an oil separation system in order to separate the oil contained in the discharged blow-by gas. The separated oil is returned to the oil circuit of the internal combustion engine. The blow-by gas released from oil is supplied again the combustion chambers of the internal combustion engine via the fresh-air system. As an alternative, the elastomer hose presented here and the hose connection presented here can also be used in the case of lines conveying any other fluid, such as raw and clean air lines for an internal combustion engine for example or lines of a motor-vehicle air-conditioning system in general and lines conveying air belonging to an air-conditioning system for ventilating a vehicle interior in particular.

A method according to the invention to manufacture such a hose connection, characterized by a two-phase installation, wherein, during a first installation phase, the support structure of the elastomer hose is attached to the counter-support structure of the nozzle in such a way that the grip structure is axially distanced away from the nozzle at the end of the first installation phase and wherein the longitudinal end is pulled up onto the nozzle during a subsequent second installation phase in such a way that the distance between the grip structure and the nozzle declines.

Other important features and advantages of the invention result from the sub claims, the drawings and the related figure description based on the drawings.

It is to be understood that the features explained in the aforementioned and following cannot only be used in the respectively indicated combination, but also in other combinations or alone, without departing from the scope of the present invention.

Preferred exemplary embodiments of the invention are represented in the drawings and will be described in more detail in the following description, wherein the same reference numbers will refer to the same or similar or functionally identical components.

### BRIEF DESCRIPTION OF THE DRAWINGS

On a schematic level respectively, the figures show

FIG. 1 to 6 respectively an isometric view of a hose connection in the case of various installation states and various perspectives,

FIG. 7 an axial view of a longitudinal end of an elastomer hose of the hose connection.

### DETAILED DESCRIPTION

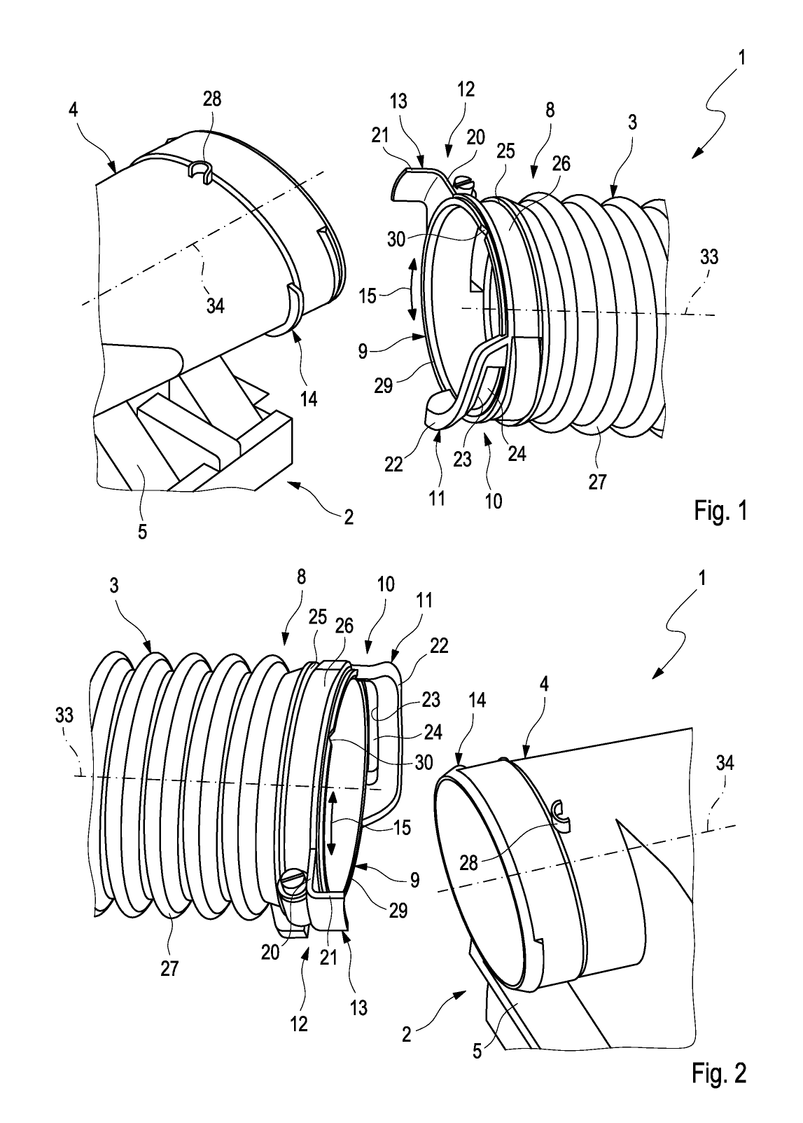

In accordance with FIG. 1 to 6, a hose connection 1, which can, for example be used within a fresh-air system 2 of an internal combustion engine (which is, by the way, not shown), and elastomer hose 3 and a nozzle 4. In the case of the example shown here, the nozzle 4 is shaped onto an air-filter housing 5 of a fresh-air system 2 as a pure example (which is, by the way, not shown). Thereby, in accordance with FIGS. 5 and 6, the elastomer hose 3 can lead to an outlet end 6 of a crankcase venting device 7 (which is, by the way, not shown) designed as a pipe section for example.

The elastomer hose serves to connect to the said nozzle 4. In FIG. 1 to 4, the elastomer hose 3 is still not connected to the hose 4; the hose connection 1 is then still not established. In FIGS. 5 and 6, the elastomer hose 3 is connected to the nozzle 4; the related hose connection 1 is then established.

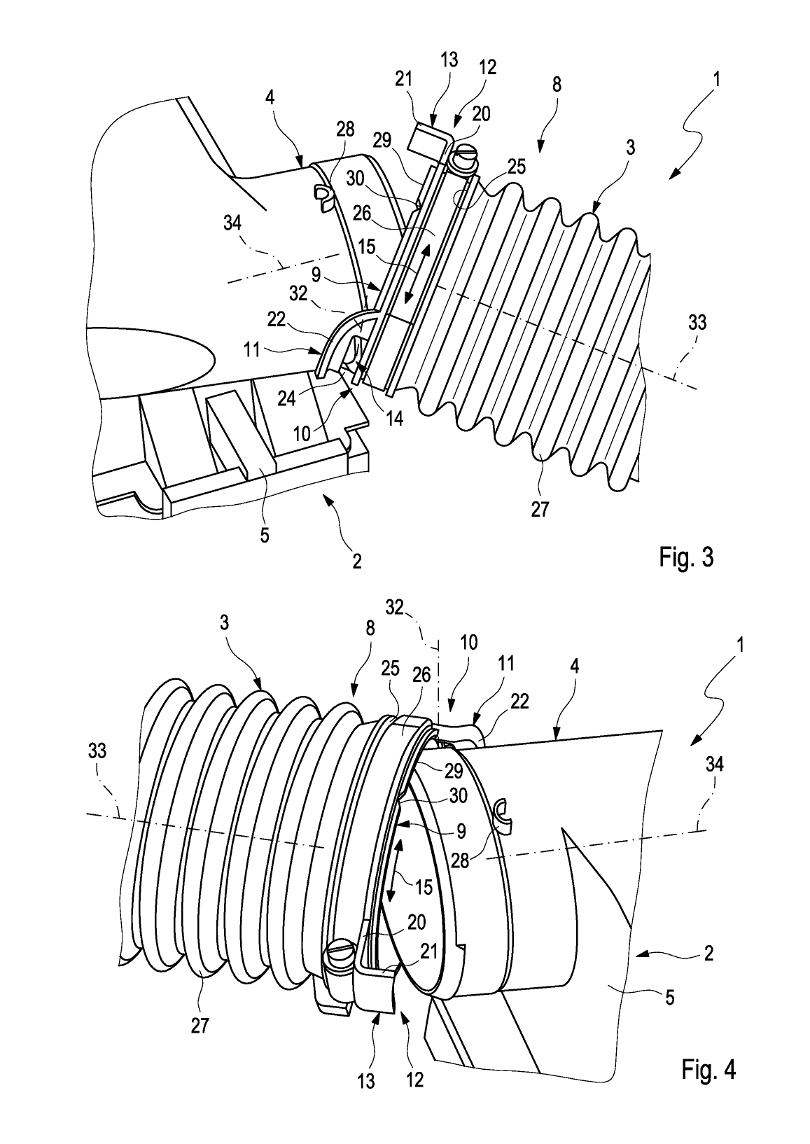

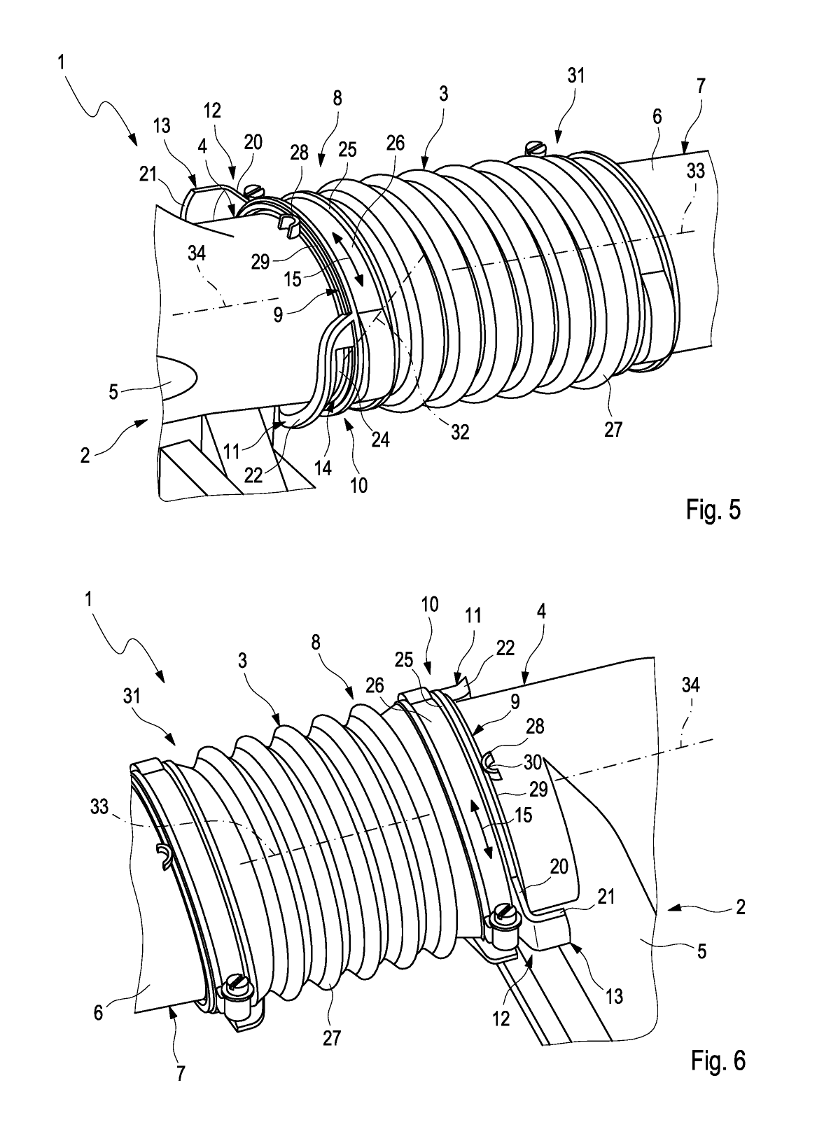

The elastomer hose 3 comprises a circumferential edge 9 at least at a longitudinal end 8, which comprises a support structure 11 protruding from the edge in a first circumferential section 10 and a grip structure 13 protruding from the edge 9 in a second circumferential section 12. The support structure 11 can be attached to the nozzle 4 on a counter-support structure 14 when connecting the elastomer hose 3 which is designed complementary to the support structure 11 and which is shaped onto the nozzle 4 in an integral manner. In FIGS. 1 and 2, this support structure 11 is not yet attached to the counter-support structure 14. In FIG. 3 to 6, in contrast, a state shown where the support structure 11 is attached to the counter-support structure 14. The grip structure 13 is designed in such a way that it can be gripped manually by the installer, for example between his/her thumb and index finger in order to be able to pull up the longitudinal end 8 of the elastomer hose 3 onto the nozzle 4 an axle direction by means of this when connecting the elastomer hose 3 to the nozzle 4. FIGS. 1 and 2 show a state before using the support structure 11 and before using the grip structure 13. After attaching the support structure 11 to the counter-support structure 14, the state in accordance with FIGS. 3 and 4 exists. Then, the grip structure 13 can be used to pull up the longitudinal end 8 onto the nozzle 4. In the state in accordance with FIGS. 5 and 6, the longitudinal end 8 is already pulled up over the nozzle 4.

The first circumferential section 10 and the second circumferential section 12 are arranged offset to each other in the circumferential direction. Thereby, the circumferential direction refers to the edge 9 on the longitudinal end 8 of the elastomer hose 3 and is indicated in the figures by a double arrow and with the number 15. The support structure 11 and the grip structure 13 extend in the circumferential direction 15 across a maximum of 90°. In the case of the example shown here, the grip structure 13 extends across a smaller angular range than the support structure 11. Thereby, an embodiment where the support structure 11 and the grip structure 13 on the edge 9 are primarily diametrically opposite to one another is preferred. The grip structure 13 is then arranged at the edge 9 offset in the circumferential direction 15 by approximately 180° to the support structure 11.

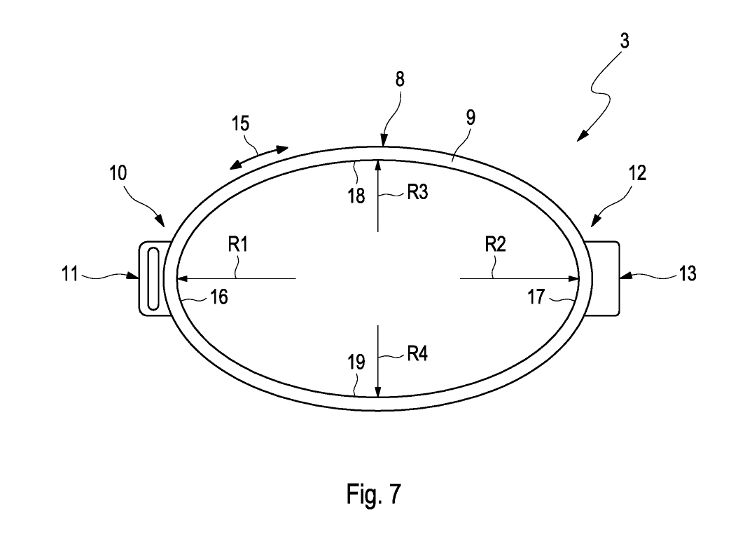

In the case of the examples shown here in FIG. 1 to 6, the elastomer hose 3 comprises a circular cross-section at least in the area of the longitudinal end 8. As a pure example, in FIG. 7, another embodiment shown where the elastomer hose 3 comprises an oval cross-section at least in the area of the longitudinal end 8. In the case of such an oval cross-section, the edge 9 possesses two short circumferential sections 16, 17 diametrically opposite to one another, which each comprise a smaller curvature radius R1 and R2, as well as two diametrically opposite long circumferential sections 18, 19, which each have a larger curvature radius R3 and R4. The long circumferential sections 18, 19 are thereby arranged into short circumferential sections 16, 17 in the circumferential direction 15 offset toward one another by 90°. In the example in FIG. 7, the oval cross-section is designed to be elliptical so that, on the one hand the small radii R1 and R2 are identical in size and, on the other hand, the large radii R3 and R4 are identical in size. In the case of such an oval cross-section or elliptical cross-section, the support structure 11 is arranged within a short circumferential section 16, while the grip structure 13 is arranged within the other short circumferential section 17.

As can be particularly seen in FIG. 1 to 6, the grip structure 13 can comprise a first grip section 20 radially protruding from the edge 9 and a second grip section 21 radially intruding from the first grip section 20. By means of this, an L-profile for the grip structure 13 results in the longitudinal end section of the longitudinal end 8. The grip structure 13 can be easily manually engaged on the grip sections 20, 21.

In contrast, the support structure 11 possesses a bracket 22 extending in the circumferential direction 15 and axially protruding from the edge 9. This bracket 22 has a support contour 23 radially on the inside, at which the counter-support contour 14 of the nozzle 4 can engage or engages in a positively form-locking manner to attach the longitudinal end 8. In the example, the bracket 22 comprises a bracket opening 24 that radially penetrates the bracket 22. As an alternative to this, an embodiment is also possible where the bracket opening 24 is only a depression and does not fully penetrate the bracket 22 in a radial direction. The previously mentioned support contour 23 axially limits the bracket opening 24 on a side remote from the edge 9. In particular, it can be provided that the bracket open 24 is immediately axially delimited by the edge 9 on a side facing the edge 9.

In the embodiments shown here, the longitudinal end 8 possesses a fully circumferential fitting groove 25 radially on the outside, into which a clamp 26 inserted. Using the clamp 26, the longitudinal end 8 attached to the nozzle 4 can be fixed to the nozzle 4. Furthermore, here, it is provided that the elastomer hose 2 is designed as a bellow 27. In another embodiment, in contrast, it can be provided that the elastomer hose 3 comprises at least one longitudinal section designed as a bellow 27.

Furthermore, the nozzle 4 can additionally comprise at least one axial end-stop 28 in addition to the counter-support contour 14, which interacts with an axial face side 29 of the edge 9 when mounting the elastomer hose 3 in order to define a predetermined axial relative position between the elastomer hose 3 and the nozzle 4. For better positioning, furthermore, it can be provided that, on the face side 29 of the edge 9, a depression 30 is formed that is complementary to the axial end-stop 28, into which the axial end-stop 28 engages in a positively form-locking manner when reaching the predetermined axial and rotary relative position. This state can be recognized in FIGS. 5 and 6. In the mounted state, the axial end-stop 28 is positioned in the circumferential direction 15 between the support structure 11 in the grip structure 13 on the face side 29 of the edge 9. Furthermore, it is provided here that to such axial and stops 28 a provided on the nozzle 4 that are diametrically opposite to one another.

Assembling the elastomer hose 3 and connecting the elastomer hose 3 to the nozzle 4 takes place in such a way that, initially, in accordance with FIGS. 1 and 2, the respective longitudinal end 8 is brought near the nozzle 4 in such a way that the support structure 11 can be hooked in at the counter-support structure 14 in order to ensure an axial fixation between the longitudinal end 8 and the nozzle 4 in this way. The approach between the elastomer hose 3 and the nozzle 4 is shown in this initial state in FIGS. 1 and 2. In contrast to this, FIGS. 3 and 4 show an intermediate state, in which the elastomer hose 3 is still not mounted to the nozzle 4, but the support structure 11 is already axially attached to the counter-support structure 14, One by one, for this purpose, the counter-support structure 14 engages into the bracket opening 24 in a positively form-locking manner. Then, the installer can grip the elastomer hose 3 on the grip structure 13 and pull it up on to the nozzle 4 subject to elastic deformation. Thereby, the longitudinal end 8 completely folds in with its edge 9 over the nozzle 4. In FIGS. 5 and 6, an end state is reached where the predetermined position between the elastomer hose 3 and the nozzle 4 has been reached. Thereby, recognizably, the edge 9 abuts the respective axial end-stop 28 on the front. As a result, the respective clamp 26 can be tightened to complete the assembly in order to fix the end state. In the case of a tightened clamp 26, the support structure 11 is relieved so that it must not contribute to the axial fixation between the elastomer hose 3 and the nozzle 4 in the assembled state of the hose connection 1. In accordance with this, support structure 11, just like the grip structure 13, is only an assembly aid to facilitate the connection of the elastomer hose 3 to the nozzle 4.

In accordance with FIGS. 5 and 6, the elastomer hose 3 can be attached at its other longitudinal end 31 in a conventional way to the pipe section of the output end 6 of the venting device 7. In principle, it is also possible that the elastomer hose 3 is also equipped with such a support structure 11 as well as with such a grip structure 13 at this other longitudinal end 31. In accordance with this, then, the output and 6 is conceived as a nozzle with a counter-support structure.

In the case of the examples shown here, the grip structure 13 and the support structure 11 are designed and arranged in such a way that a two-phase installation can be implemented to connect the elastomer hose 3 to the nozzle 4, meaning when producing the hose connection 1, wherein, during a first installation phase, the support structure 11 of the elastomer hose 3 is attached to the counter-support structure 14 of the nozzle 4 in such a way that the grip structure 13 is axially distanced away from the nozzle 4 at the end of the first installation phase and wherein the longitudinal end 8 of the elastomer hose 3 is pulled up onto the nozzle 4 during a subsequent second installation phase in such a way that the distance between the grip structure 13 and the nozzle 4 declines.

In addition or as an alternative, it can be provided that the support structure 11 or the counter-support structure 14 are designed and/or match each other in such a way that the support structure 11 attached to the counter-support structure 14 defines a swivel axis 32, around which the longitudinal end 8 of the elastomer hose 3 can be swivelled when pulling up over the nozzle 4. Furthermore, the longitudinal end 8 of the elastomer hose 3 defines a hose-longitudinal centre axis 33 while the nozzle 4 defines a nozzle-longitudinal centre axis 34. The swivel axis 32 extends perpendicular to the hose-longitudinal centre axis 33 and perpendicular to the nozzle-longitudinal centre axis 34.

After the first assembly phase and before the second assembly phase, meaning after attaching the support structure 11 of the elastomer hose 3 to the counter-support structure 14 of the nozzle 4 and before pulling up the longitudinal end 8 onto the nozzle 4, the hose-longitudinal centre axis 33 runs at an incline to the nozzle-longitudinal centre axis 34. After the second assembly phase, meaning after attaching the support structure 11 of the elastomer hose 3 to the counter-support structure 14 of the nozzle 4 and after pulling up the longitudinal end 8 onto the nozzle 4, the hose-longitudinal centre axis 33 runs parallel to the nozzle-longitudinal centre axis 34.

A method to establish a hose connection 1 is therefore characterized by a two-phase assembly process as described in the above. In FIGS. 1 and 2, a state is evident, which represents the start the first assembly phase. Support structure 11 and grip structure 13 are still axially spaced away by the nozzle 4. The hose-longitudinal centre axis 33 in the nozzle-longitudinal centre axis 34 can run and inclined to another. FIGS. 3 and 4 show the end of the first assembly phase and the start the second assembly phase so that the support section 11 is attached to the counter-support section 14 while the grip section 13 is still axially spaced away from the nozzle 4. As a consequence, the hose-longitudinal centre axis 33 and the nozzle-longitudinal centre axis 34 are orientated and inclined to one another. Support section 11 and the counter-support section 14 defined the swivel axis 32 around which the longitudinal end 8 can be swivelled relative to the nozzle 4. This swivel movement allows the axial distance of the grip section 13 from the nozzle 4 to change. At the same time, been means of this the inclination of the hose-longitudinal centre axis 33 to the nozzle-longitudinal centre axis 34 and be changed. FIGS. 5 and 6 then show the end of the second assembly phase so that the longitudinal end 8 is pulled onto the nozzle 4. At the same time, by means of this, the hose-longitudinal centre axis 33 and the nozzle-longitudinal centre axis 34 are orientated parallel to one another.

1. An elastomer hose to connect to a nozzle, the elastomer hose comprising:
a circumferential edge at least at a longitudinal end of the elastomer hose;
a support structure protruding from a first circumferential section of the circumferential edge and by which the longitudinal end of the elastomer hose is connectable in a positively form-locking manner to a complementary counter-support structure on the nozzle; and
a grip structure protruding from the circumferential edge in a second circumferential section, which is offset from the first circumferential section in a circumferential direction, at which the longitudinal end is manually grippable when connecting the elastomer hose to the nozzle and axially pullable up on to the nozzle.

2. The elastomer hose according to claim 1, wherein at least one of:
the support structure extends in the circumferential direction across a maximum of 90°; and
the grip structure extends across a maximum of 90° in the circumferential direction.

3. The elastomer hose according to claim 1, wherein the grip structure is offset from the support structure by at least 90° and a maximum of 180° in the circumferential direction.

4. The elastomer hose according to claim 1, wherein the support structure and the grip structure are arranged diametrically opposite to one another.

5. The elastomer hose according to claim 1, wherein:
the longitudinal end has an oval cross-section such that the circumferential edge has two diametrically opposite short circumferential sections and two diametrically opposite long circumferential sections, the long circumferential sections having curvature of radii that are larger than and offset by 90° from curvature of radii of the short circumferential sections; and
the support structure is arranged within one of the short circumferential sections and the grip structure is arranged within the other of the short circumferential sections.

6. The elastomer hose according to claim 1, wherein the grip structure includes a first grip section radially protruding from the circumferential edge and a second grip section axially protruding from the first grip section.

7. The elastomer hose according to claim 1, wherein the support structure includes a bracket that axially protrudes from the circumferential edge and extends in the circumferential direction, the bracket having a holding contour inside in a radial direction and on which the counter-support structure is engageable in the positively form-locking manner to attach the longitudinal end.

8. The elastomer hose according to claim 7, wherein:
the bracket includes a bracket opening that extends radially into the bracket; and
the holding contour axially limits the bracket opening on a side remote from the circumferential edge.

9. The elastomer hose according to claim 1, wherein the longitudinal end has a circumferential fitting groove radially on an outside of the elastomer hose, into which a clamp is insertable to attach the longitudinal end on the nozzle.

10. The elastomer hose according to claim 1, wherein the elastomer hose is designed as a bellow or includes at least one longitudinal section designed as a bellow.

11. A hose connection comprising:
an elastomer hose having:
a circumferential edge at least at a longitudinal end of the elastomer hose;
a support structure protruding from a first circumferential section of the circumferential edge; and
a grip structure protruding from the circumferential edge in a second circumferential section, which is offset from the first circumferential section in a circumferential direction, at which the longitudinal end is manually grippable; and
a nozzle having a counter-support structure on an outside of the nozzle, the counter-support structure being formed complementary to and engageable with the support structure of the elastomer hose in a positively form-locking manner to connect the longitudinal end of the elastomer hose to the nozzle.

12. The hose connection according to claim 11, wherein the nozzle includes at least one axial end-stop on the outside, which interacts with an axial face side of the circumferential edge when connecting the elastomer hose.

13. The hose connection according to claim 12, wherein the axial end-stop abuts the axial face side of the circumferential edge in the circumferential direction between the support structure and the grip structure.

14. The hose connection according to claim 12, wherein the at least one axial end-stop includes two axial end-stops diametrically opposite to one another.

15. The hose connection according to claim 11, wherein:
the grip structure and the support structure are configured such that the elastomer hose and the nozzle are connectable to each other via a two-phase assembly;
during a first assembly phase, the support structure of the elastomer hose is attached to the counter-support structure of the nozzle in such a way that the grip structure is axially spaced away from the nozzle at an end of the first assembly phase; and
during a second assembly phase, the longitudinal end of the elastomer hose is pulled up onto the nozzle in such a way that a distance between the grip structure and the nozzle decreases.

16. The hose connection according to claim 11, wherein the support structure and the counter-support structure are designed to match each other in such a way that the support structure and the counter-support structure, when attached to each other, define a swivel axis around which the longitudinal end of the elastomer hose is able to be swiveled when being pulled up over the nozzle.

17. The hose connection according to claim 11, wherein:
the longitudinal end of the elastomer hose defines a hose-longitudinal centre axis;
the nozzle defines a nozzle-longitudinal centre axis;
after attaching the support structure of the elastomer hose to the counter-support structure of the nozzle and before pulling up the longitudinal end onto the nozzle 4, the hose-longitudinal centre axis runs at an incline to or parallel to the nozzle-longitudinal centre axis.

18. A method to produce a hose connection having an elastomer hose and a nozzle, the method comprising:
during a first assembly phase, attaching a support structure of the elastomer hose to a counter-support structure of the nozzle in such a way that a grip structure of the elastomer hose is axially spaced away from the nozzle at the end of the first assembly phase, the support structure and the grip structure protruding from respective circumferential sections of a circumferential edge offset from each other in a circumferential direction at a longitudinal end of the elastomer hose; and
during a subsequent second assembly phase, pulling the longitudinal end onto the nozzle in such a way that the distance between the grip structure and the nozzle decreases.

19. The method according to claim 18, wherein pulling the longitudinal end onto the nozzle includes swiveling the longitudinal end of the elastomer hose around a swivel axis defined by the support structure and the counter-support structure when attached to each other during the first assembly phase.

20. The method according to claim 18, wherein at the end of the first assembly phase, a hose-longitudinal centre axis defined by the longitudinal end of the elastomer hose runs at an incline to or parallel to a nozzle-longitudinal centre axis defined by the nozzle.
